(19) United States
(12) Patent Application Publication
(10) Pub. No.: US 2021/0209147 A1
(43) Pub. Date: Jul. 8, 2021

(54) PRECISION RECALL IN VOICE COMPUTING

(71) Applicant: Strengths, Inc., Provo, UT (US)

(72) Inventors: Paul B. Allen, Provo, UT (US); Clinton Carlos, Mesa, AZ (US)

(73) Assignee: Strengths, Inc., Provo, UT (US)

(21) Appl. No.: 17/143,137

(22) Filed: Jan. 6, 2021

Related U.S. Application Data
(60) Provisional application No. 62/957,738, filed on Jan. 6, 2020.

(51) Int. Cl. G06F 16/432; G06F 3/16; G06F 16/438; G10L 15/22; G06F 16/48

(52) U.S. Cl. CPC G06F 16/433; G06F 3/167; G10L 2015/223; G10L 15/22; G06F 16/48; G06F 16/438

(57) ABSTRACT

A voice computing environment includes a library of items, each item having one or more excerpts. Users are enabled to assign a unique voice tag to each item in the library. Each voice tag comprises three words or less. The system monitors for potential duplicate voice tags in the library. When such duplicates are detected, one or more alternative voice tags are recommended to the user.

This application claims the benefit of U.S. Provisional Patent Application Ser. No. 62/957,738 (Attorney Docket 333.001USPR) filed on Jan. 6, 2020, entitled “PRECISION RECALL IN VOICE COMPUTING”, the entirety of which is incorporated herein by reference.

### BACKGROUND

Voice-enabled computing devices are becoming more prevalent. An individual speaks a command to activate such a device. In response to a voice command, the device performs various functions, such as outputting audio.

Voice computing will soon be used by billions of people. Retrieving content with voice commands is a very different user experience than typing keywords into a search engine which has indexed billions of pages of content and has an advanced algorithm to surface the most relevant or highest value content. With voice, it would be extremely frustrating and time consuming to listen to all kinds of possible hits. With screen computing, one can quickly scan the pages and immediately find the relevant page to click on.

### SUMMARY

In one exemplary embodiment, a method comprises creating a library of items, each item having one or more excerpts. The method further comprises enabling a user to add new items to the library and to assign a unique voice tag to each new item as it is added to the library. The method further comprises adding metadata about each new item to an index as the new item is added to the library, together with the unique voice tag assigned to the new item by the user. The method further comprises monitoring for potential duplicate voice tags in the library. When such duplicates are detected, one or more alternative voice tags are recommended to the user.

In another exemplary embodiment, a system comprises a library of items, each item having one or more excerpts. The system further comprises an index comprising metadata about each item in the library and a plurality of unique voice tags. Each voice tag corresponds to one item in the library. The system further comprises a voice tag assignment module configured to enable a user to assign new voice tags to new items as they are added to the library. The voice tag assignment module is configured to prevent a user from assigning a duplicate voice tag to a new item as it is added to the library.

In another exemplary embodiment, a method comprises receiving a voice instruction from a user. The voice instruction comprises a command portion and a voice tag portion. The voice tag portion comprises a voice tag corresponding to an item in a library, and the voice tag being assigned to the corresponding item by a user when the corresponding item was added to the library. The method further comprises parsing the voice instruction to identify the command portion and the voice tag portion, and processing the voice tag portion to identify the item in the library corresponding to the voice tag. The method further comprises accessing the item in the library corresponding to the voice tag, and processing the command portion to carry out a desired function on the accessed item, in accordance with the voice instruction.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates a block diagram of an example system for adding items to a personal library in a voice computing environment;

FIG. 2 illustrates a block diagram of an example system for adding items to a universal library in a voice computing environment;

FIGS. 3A, 3B, and 3C illustrate screenshots of an example user interface for accessing items in a voice computing environment;

FIG. 4 illustrates a block diagram of an example system for retrieving items from a universal library in a voice computing environment.

In accordance with common practice, the various described features are not drawn to scale but are drawn to emphasize specific features relevant to the exemplary embodiments.

### DETAILED DESCRIPTION

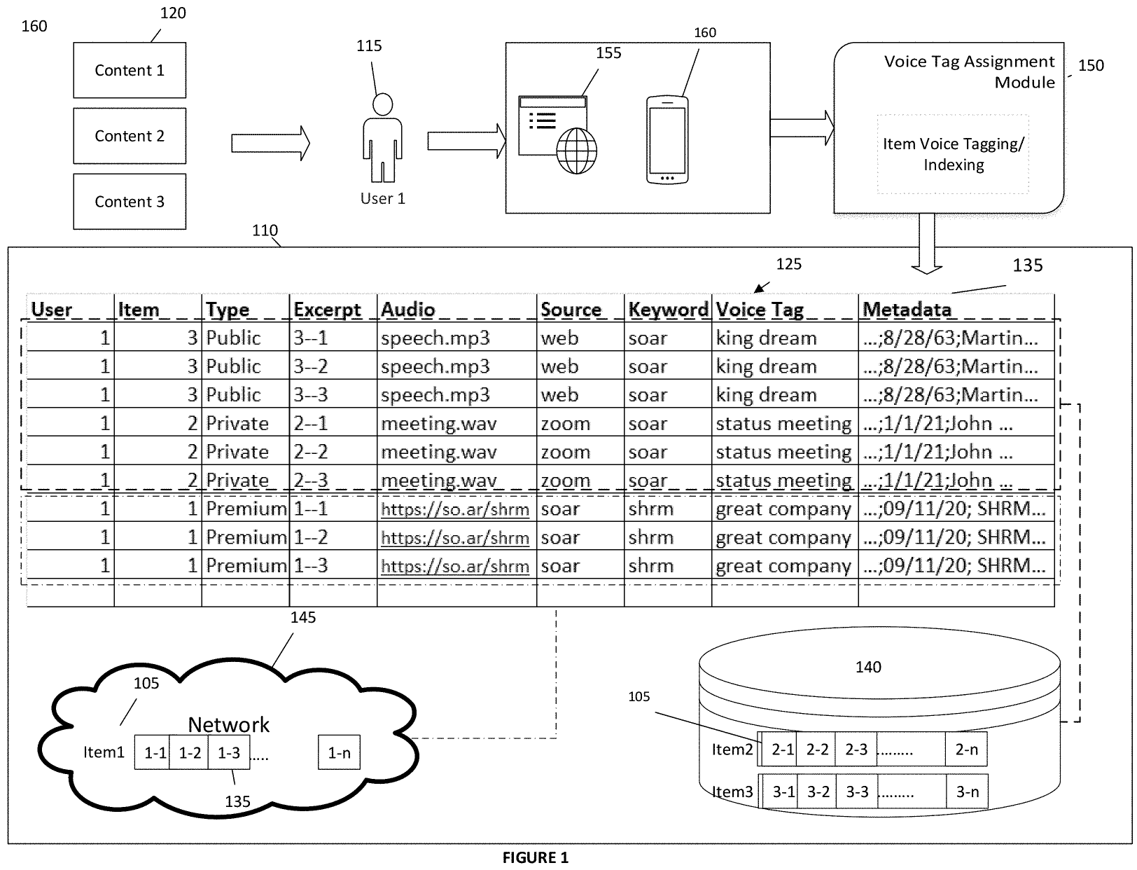

FIG. 1 illustrates a block diagram of an example system 100 for adding items 105 to a personal library 110 of a user 115 in a voice computing environment. In the illustrated embodiment, the user 115 can select one or more pieces of content 120 to be added to the user's personal library 110. The content 120 may comprise a wide variety of suitable file formats, such as audio, video, text, images, webpages, presentations, etc. When content 120 is selected by the user 115, it is ingested as an item 105 in the user's personal library 110.

When an item 105 is ingested into a personal library 110, it may be transcribed and parsed into one or more excerpts 130, or clips. For example, as shown in FIG. 1, Item 1 may be parsed into n excerpts 130 labeled 1-1, 1-2, 1-3, . . . , 1-n, Item 2 may be parsed into n excerpts 130 labeled 2-1, 2-2, 2-3, . . . , 2-n, and so on. At the same time, the user 115 assigns a unique voice tag 125, or “quick phrase,” to each item 105 in their personal library 110. Each voice tag 125 comprises a unique combination of one, two, three or more words, which enables the user 115 to retrieve an item 105 simply by speaking the corresponding voice tag 125. The voice tags 125 are stored in an index 135, together with fields about the corresponding items 105, such as user, type, excerpt, audio, source, keyword, and additional metadata (e.g., author, date, transcript, etc.).

In some cases, items 105 (e.g., Item 2 and Item 3 in FIG. 1) are uploaded to a personal file store 140 when they are ingested into a personal library 110. The personal file store 140 may store files on any suitable storage platform, such as a local hard drive, file server, or cloud storage platform (e.g., AWS). In other cases, items 105 (e.g., Item 1 in FIG. 1) are not uploaded or saved in the personal file store 140, but remain accessible to the user 115 through a suitable network 145, such as the Internet or an organizational intranet. In such cases, the index 135 comprises an appropriate address (e.g., hyperlink) through which the item 105 can be accessed via the network 145 rather than the personal file store 140, as shown in FIG. 1.

In operation, the user 115 may assign a voice tag 125 to an item 105 using a voice tag assignment module 150, accessible via a website 155 or mobile application 160, for example. In some embodiments, the voice tag assignment module 150 may recommend voice tags 125 that are unique, easy to remember (e.g., short words related to the text), and comprise words that work well in voice computing.

For example, if the user 115 selects a voice tag 125 that has been used previously, the voice tag assignment module 150 may detect the conflict, and recommend an alternative, unique voice tag 125. It is known that a set of 40,000 unique words in English can be combined to form approximately 64 trillion unique three-word combinations, i.e., 40,000³=64 trillion. Thus, even if each voice tag 125 is relatively short (e.g., three words or less), the index 135 may comprise a vast namespace with trillions of unique items 105 or excerpts 130, each having a corresponding unique voice tag 125.

It is also known that voice computing systems perform well on some words, but poorly on other words, such as names or words that sound like other words. Thus, the voice tag assignment module 150 may suggest that the user 115 avoid such problematic words when assigning voice tags 125.

To provide a specific example, Item 1 shown in FIG. 1 may comprise a recording of presentation made at a professional conference. When Item 1 was ingested into the personal library 110, User 1 assigned it the two-word voice tag 125, “Great Company.” At the time, the voice tag assignment module 150 confirmed that the selected voice tag 125 was unique and free of problematic voice computing words. Accordingly, the voice tag 125 was added to the index 135, together with appropriate metadata about the corresponding item 105, as shown in FIG. 1.

As another example, Item 2 shown in FIG. 1 may comprise a recording of an audio call or videoconference between the user 115 and a coworker about the status of a project. When Item 2 was ingested into the personal library 110, User 1 assigned it the two-word voice tag 125, “Status Meeting.” At the time, the voice tag assignment module 150 confirmed that the selected voice tag 125 was unique and free of problematic voice computing words. Accordingly, the voice tag 125 was added to the index 135, together with appropriate metadata about the corresponding item 105, as shown in FIG. 1.

As another example, Item 3 shown in FIG. 1 may comprise an audio or video recording of Dr. Martin Luther King's famous “I Have A Dream” speech from August 1963. When Item 3 was ingested into the personal library 110, User 1 assigned it the two-word voice tag 125, “King Dream.” At the time, the voice tag assignment module 150 confirmed that the selected voice tag 125 was unique and free of problematic voice computing words. Accordingly, the voice tag 125 was added to the index 135, together with appropriate metadata about the corresponding item 105, as shown in FIG. 1.

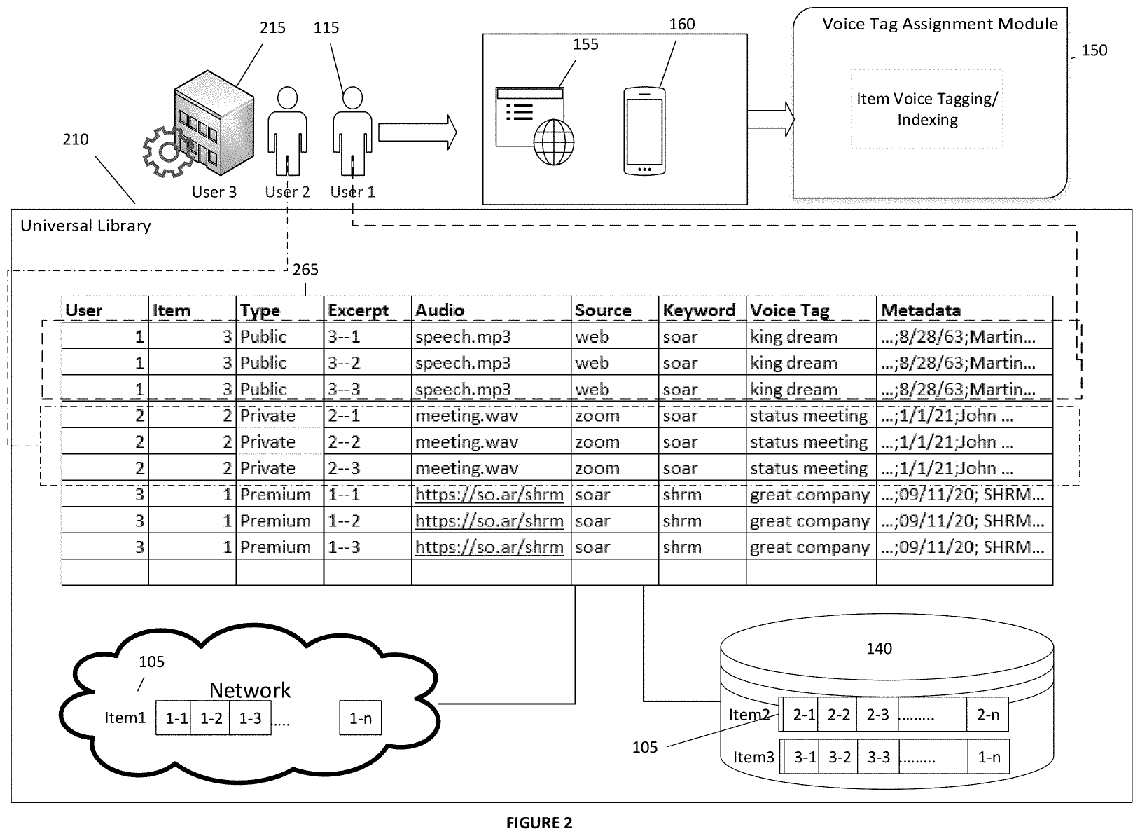

FIG. 2 illustrates a block diagram of an example system 200 for adding items 105 to a universal library 210, or shared library, in a voice computing environment. Unlike the personal library 110 of FIG. 1, the universal library 210 may include items 105 or excerpts 130 added by more than one user 115 and accessible to more than one user 115. In some embodiments, when users 115 are adding items 105 to their personal libraries 110, they may be asked if they want to add the items 105 to a universal library 210. For example, in the embodiment shown in FIG. 2, content (not shown) has been added to the universal library 210 by two individual users 115, as well as an organizational user 215, using systems and methods similar to those described above in connection with FIG. 1. In some embodiments, organizational users 215 may use automated processes to add large numbers of items 105 or excerpts 130 to the universal library 210. In the particular example shown in FIG. 2, Item 1 was added to the universal library 210 by organizational User 3, Item 2 was added to the universal library 210 by individual User 2, and Item 3 was added to the universal library 210 by individual User 1.

In some embodiments, individual users 115 or organizational users 215 may be compensated for their contributions to the universal library 210. For example, usage of the universal library 210 by paying subscribers may be tracked, and a percentage of revenues paid to the individual users 115 or organizational users 215 that contributed the items 105 or excerpts 130 to the universal library 210, based on usage.

The universal library 210 comprises an index 135 with a “Type” field indicating who can access the corresponding items 105 or excerpts 130. For example, as shown in FIG. 2, Item 2 was marked “Private” when it was added to the universal library 210 by User 2, meaning that Item 2 is accessible only to User 2. Item 3 was marked “Public” when it was added to the universal library 210 by User 1, meaning that Item 3 is accessible to all users. Item 1 was marked “Premium” when it was added to the universal library 210 by User 3, meaning that Item 1 is accessible only to a designated group of authorized users 115, such as users 115 who pay for access to premium content, or employees of an organizational user.

In operation, individual users 115 and organizational users 215 may assign unique voice tags 125 to items 105 using the voice tag assignment module 150, as described above. When analyzing potential namespace conflicts in the universal library 210, additional metadata beyond the voice tag 125 can be considered to uniquely identify items 105 in the index 135. For example, if two users 115 assigned the same voice tag 125 (e.g., “Acme Merger Call”) to two different items 105 marked private in their personal libraries, no conflict would arise because the items do not exist in the same public namespace. On the other hand, if both items 105 were marked public, a namespace conflict would arise, and the second user 115 would be prompted to select a different, unique voice tag 125. In such cases, the second user 115 may choose a related voice tag 125 (e.g., “Acme Merger Discussion”) or an unrelated voice tag 125 (e.g., “Apple Banana Orange”).

In some embodiments, a universal library 210 can be replicated to create a new namespace for a given organizational user 215. For example, an organization name (e.g., CSPAN) can be added to the keyword field of the index 135 to create an organizational library with a unique namespace. The organization name or other keywords can be combined with the unique voice tags 125 to identify and access particular versions of items 105 in the universal library 210. As an example, “CSPAN King Dream” may correspond to the CSPAN version of the King “I Have a Dream” speech, or billions of other audio clips. In some cases, individual users 115 and organizational users 215 may have access to different libraries, and could be directed to a particular library based on a voice tag 125 combined with one or more keywords.

In addition to voice tags 125 and keywords, the index 135 can also include “meaningful phrases” added by users 115 as additional metadata corresponding to items 105 in the universal library 210. In some embodiments, the index 135 may also comprise a full transcript with every word of every item 105 in the universal library 210, accessible via a full-text voice search engine. Meaningful phrases and full transcripts can be searched and multiple possible “hits” can be presented to the user 115, whereas with voice tags 125, the system 200 looks for a substantially exact match, the single item that best matches the voice tag 125, for retrieval.

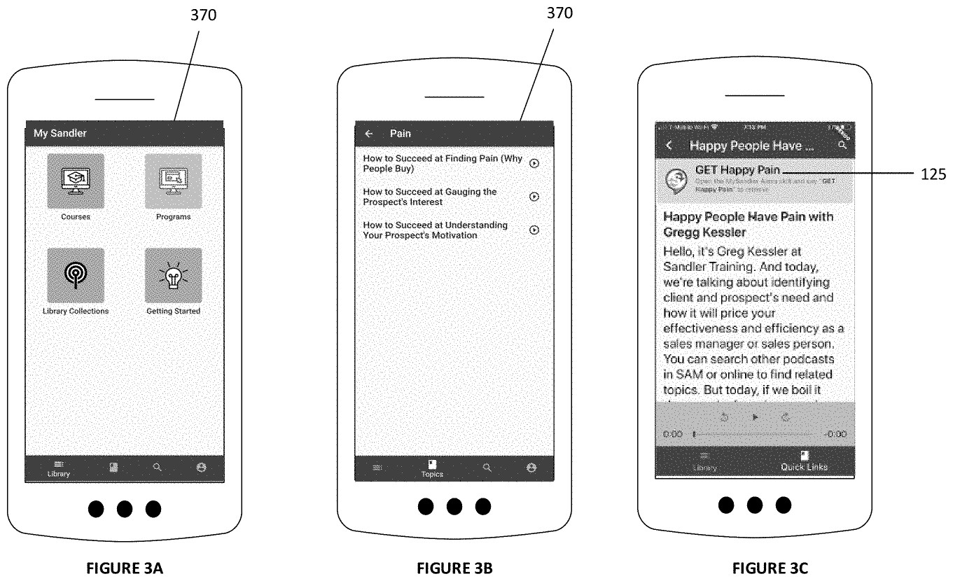

FIGS. 3A-3C illustrate screenshots of an example user interface 370 for accessing items 105 in a voice computing environment. In the illustrated embodiment, the user interface 370 comprises an application on a mobile computing device, such as a smart phone or tablet computer. In operation, the user interface 370 can be used to browse for items 105 in a universal library 210, as shown in FIG. 3A. The user interface 370 can also be used to search for items 105 in a universal library 210, as shown in FIG. 3B. Once a desired item 105 has been selected, the user interface 370 can be used to play or share the item 105, as shown in FIG. 3C. In some embodiments, the user interface 370 allows users 115 to access all items 105 in their personal library 110, as well as access all items 105 in one or more universal libraries 210 to which the user 115 has access.

For example, in the embodiment illustrated in FIG. 3C, the user interface 370 shows the two-word voice tag 125 “Happy Pain” in connection with an item 105 entitled “Happy People Have Pain with Gregg Kessler.” By seeing voice tags 125 on their devices, individuals will advantageously be enabled to memorize the voice tags 125 over time. Thus, individuals will advantageously be enabled to access the corresponding items or excerpts from any voice-enabled computing device in the world simply by speaking the corresponding voice tag 125.

In other embodiments, users may see or hear voice tags 125 through a wide variety of possible user interfaces, such as websites, printed publications, broadcasts, posts, etc. Users can access such interfaces through a wide variety of suitable devices or media, such as computing devices (e.g., notebook computers, ultrabooks, tablet computers, mobile phones, smart phones, personal data assistants, video gaming consoles, televisions, set top boxes, smart televisions, portable media players, and wearable computers (e.g., smart watches, smart glasses, bracelets, etc.), display screens, displayless devices (e.g., Amazon Echo), other types of display-based devices, smart furniture, smart household devices, smart vehicles, smart transportation devices, and/or smart accessories, among others), static displays (e.g., billboards, signs, etc.), publications (e.g., books, magazines, pamphlets, flyers, mailers, etc.).

In some embodiments, when a voice tag 125 is displayed visually, it can be preceded by a selected designator, such as the ∞ character (ASCII code 236) or the ˜ character (ASCII code 126). For example, the voice tag 125 “King Dream” may be displayed or printed as ∞KingDream or ˜KingDream. Seeing the selected designator will let users 115 know that the text that follows is a voice tag 125, and they can access the corresponding item 105 or excerpt 130 by saying the voice tag 125 near a suitable voice-enabled computing device.

In some embodiments, a voice tag 125 can also function as a hypertext link to a unique URL following a predictable naming convention, such as: https://play.soar.com/Voice-Tag. For example, the voice tag 125 ˜KingDream may correspond to the following URL: https://play.soar.com/King-Dream. In some embodiments, when such a voice tag 125 is displayed on a computing device, a user 115 can select the hyperlink to navigate directly to the corresponding URL. In some embodiments, when the user's web browser retrieves the selected URL and the corresponding item 105 or excerpt 130 is a media file, playback may begin automatically.

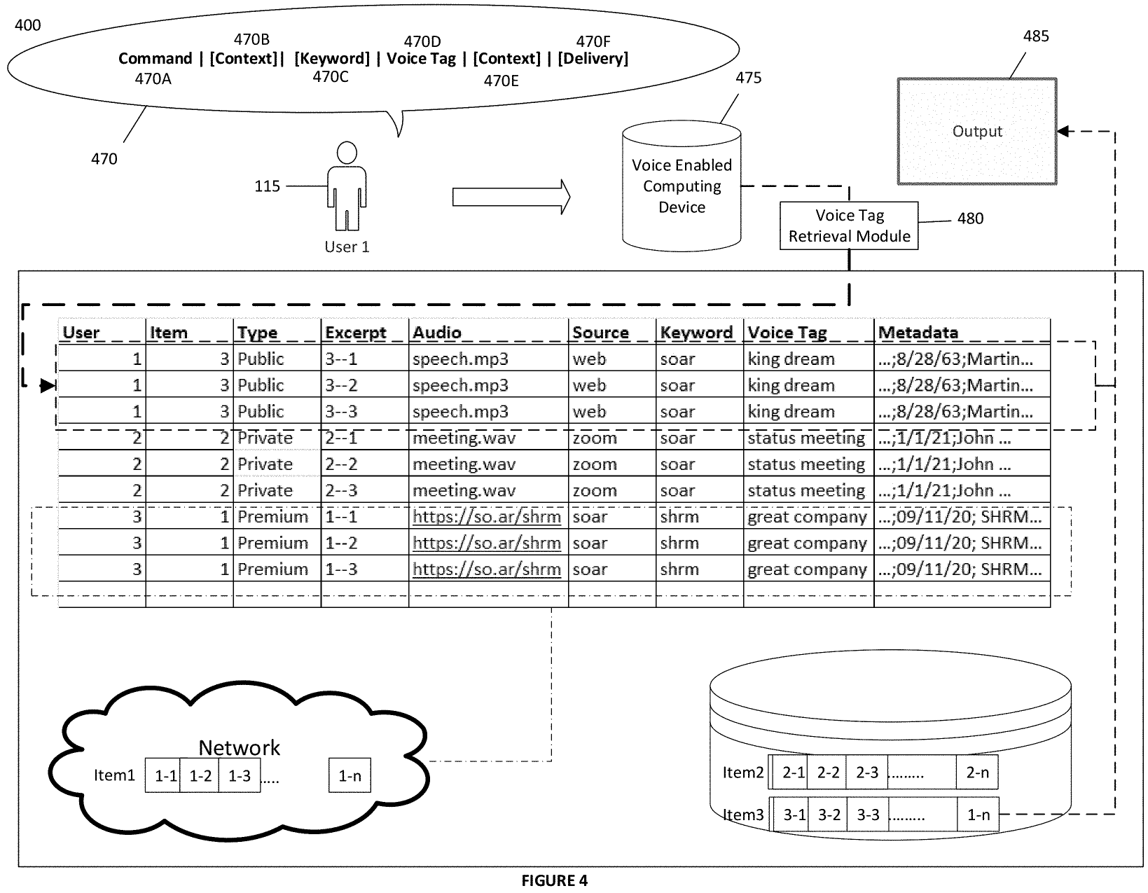

FIG. 4 illustrates a block diagram of an example system 400 for retrieving items 105 or excerpts 130 from a universal library 210 of a voice computing environment. In the illustrated embodiment, the user 115 can initiate retrieval by speaking a voice instruction 470 within a detection range of a voice-enabled computing device 475. Although the voice-enabled computing device 475 is illustrated as a smart speaker (e.g., an Amazon Echo or Google Home), it should be understood that various other types of electronic devices that are capable of receiving and processing communications can be used in accordance with various embodiments discussed herein. These devices can include, for example, notebook computers, ultrabooks, personal data assistants, video gaming consoles, televisions, set top boxes, smart televisions, portable media players, unmanned devices (e.g., drones or autonomous vehicles), wearable computers (e.g., smart watches, smart glasses, bracelets, etc.), display screens, display-less devices, virtual reality headsets, display-based devices, smart furniture, smart household devices, smart vehicles, smart transportation devices, and/or smart accessories, among others.

In operation, when the voice-enabled computing device 475 receives the voice instruction 470, the device 475 activates the voice tag retrieval module 480 to access a selected item 105 or excerpt 130 and deliver it via output 485, in accordance with the voice instruction 470. In some embodiments, before the user 115 speaks the voice instruction 470, the user may say a “wakeword” (e.g., “Alexa,” “OK Google,” etc.) and another voice command (e.g., “Open Soar Audio,” etc.) to launch the voice tag retrieval module 480. In some embodiments, the voice instruction 470 may comprise a command portion 470A (e.g., “GET,” “SHARE,” etc.), an optional first context portion 470B (e.g., “from the web,” etc.), an optional keyword portion 470C (e.g., “Soar,” “CSPAN,” etc.), a voice tag portion 470D (e.g., “Happy Pain,” “King Dream,” etc.), an optional second context portion 470E (e.g., “from 1963,” etc.), and an optional delivery portion 470E (e.g., “on my phone,” “to my family,” etc.).

The voice instruction 470 may be audio data analyzed to identify and convert the words represented in the audio data into tokenized text. This can include, for example, processing the audio data using an automatic speech recognition (ASR) module (not shown) that is able to recognize human speech in the audio data and then separate the words of the speech into individual tokens that can be sent to a natural language understanding (NLU) module (not shown), or other such system or service. The tokens can be processed by the NLU module to attempt to determine a slot or purpose for each of the words in the audio data. For example, the NLU module can attempt to identify the individual words, determine context for the words based at least in part upon their relative placement and context, and then determine various purposes for portions of the audio data.

For example, the NLU module can process the words “GET King Dream on my phone” together to identify this phrase as a voice instruction 470. There can be variations to such an intent, but words such as “GET” or “SHARE” can function as a primary trigger word, for example, which can cause the NLU module to look for related words that are proximate the trigger word in the audio data. Other variations such as “I want to SHARE” may also utilize the same trigger word, such that the NLU may need to utilize context, machine learning, or other approaches to properly identify the intent. In this particular example, the voice tag retrieval module 480 will parse the voice instruction 470 and will identify the word “GET” as the command portion 470A, the words “King Dream” as the voice tag portion 470D, and the words “on my phone” as the optional delivery portion 470F. Accordingly, the voice tag retrieval module 480 will retrieve Item 3 from the universal library 210, and deliver it to the user 115 via output 485, which in this case will be a device previously identified as the user's phone. In some embodiments, Item 3 will begin playing automatically on the user's phone.

As another example, the voice instruction 470 may comprise the phrase “GET King Dream,” without any additional context modifiers or keywords. In this example, the voice tag retrieval module 480 will retrieve Item 3 from the universal library 210, and deliver it to the user 115 via output 485, which in this case will be the voice-enabled computing device 475, because the voice instruction 470 did not include the optional delivery portion 470F.

As another example, the voice instruction 470 may comprise the SHARE command, which advantageously enables users 115 to designate any number of individuals or groups with whom they will be able to immediately share selected items 105 or excerpts 130. For example, the voice instruction 470 may comprise the phrase “SHARE King Dream with my family.” In this example, the voice tag retrieval module 480 will parse the voice instruction 470 and will identify the word “SHARE” as the command portion 470A, the words “King Dream” as the voice tag portion 470D, and the words “with my family” as the optional delivery portion 470F. Accordingly, the voice tag retrieval module 480 will retrieve Item 3 from the universal library 210, and deliver it via output 485, which in this case will be a group of individuals previously designated as the user's family. In some embodiments, the selected item 105 or excerpt 130 will be delivered to each family member through their preferred delivery method, as described below.

In some embodiments, the voice tag retrieval module 480 may reference an account of the user 115 to identify individuals designated as members of the user's family. In another example, if the user 115 desired to share an item 105 or excerpt 130 with another identifiable group of individuals (e.g., coworkers, clients, club members, etc.), the voice tag retrieval module 480 may reference the user's account to find the individuals designated as members of the desired group. In some embodiments, the voice tag retrieval module 480 may check user preferences to determine how to share the selected item 105 or excerpt 130 with each individual. For example, a user 115 may create a profile and indicate a preferred delivery method, such as a voice assistant (e.g., Amazon Echo, Google Home, etc.), email, SMS, WhatsApp, Facebook Messenger, etc. In some embodiments, a voice assistant can send “notifications” to individual users, to let them know that new content is available. For example, an indicator light may illuminate to indicate that new notifications or messages have been received.

In other examples, the voice instruction 470 may comprise a phrase such as “SHARE King Dream on Facebook” or “SHARE King Dream on Twitter.” In these example, the voice tag retrieval module 480 will parse the voice instruction 470 and will identify the word “SHARE” as the command portion 470A, the words “King Dream” as the voice tag portion 470D, and the words “on Facebook” or “on Twitter” as the optional delivery portion 470F. Accordingly, the voice tag retrieval module 480 will retrieve Item 3 from the universal library 210, and deliver it via output 485, which in this case will be a social media account previously designated by the user 115.

The specification and drawings are to be regarded in an illustrative rather than a restrictive sense. It will, however, be evident that various modifications and changes may be made thereunto without departing from the broader spirit and scope of the invention as set forth in the claims.

What is claimed is:

1. A method comprising:
creating a library of items, each item having one or more excerpts;
enabling a user to add new items to the library and to assign a unique voice tag to each new item as it is added to the library;
adding metadata about each new item to an index as the new item is added to the library, together with the unique voice tag assigned to the new item by the user; and
monitoring for potential duplicate voice tags in the index, and when such duplicates are detected, recommending one or more alternative voice tags to the user.

2. The method of claim 1, wherein each voice tag comprising three words or less.

3. The method of claim 1, wherein the library comprises a personal library unique to the user.

4. The method of claim 1, wherein the library comprises a universal library comprising items added by more than one user or accessible to more than one user.

5. The method of claim 1, wherein the items comprise audio, video, text, images, webpages, or presentations.

6. The method of claim 1, wherein enabling a user to assign a unique voice tag to each new item comprises presenting the user with a voice tag assignment module accessible via a website or mobile application.

7. The method of claim 1, wherein recommending alternative voice tags to a user comprises recommending avoiding problematic words for voice computing systems.

8. A system comprising:
a library of items, each item having one or more excerpts;
an index comprising metadata about each item in the library and a plurality of unique voice tags, each voice tag corresponding to one item in the library; and
a voice tag assignment module configured to enable a user to assign new voice tags to new items as they are added to the library,
wherein the voice tag assignment module is configured to prevent a user from assigning a duplicate voice tag to a new item as it is added to the library.

9. The system of claim 8, wherein each voice tag comprises three words or less.

10. The system of claim 8, wherein the library comprises a personal library unique to the user.

11. The system of claim 8, wherein the library comprises a universal library comprising items added by more than one user or accessible to more than one user.

12. The system of claim 8, wherein the items comprise audio, video, text, images, webpages, or presentations.

13. The system of claim 8, wherein the voice tag assignment module is accessible to the user via a website or mobile application.

14. The system of claim 8, wherein the voice tag assignment module is configured to prevent a user from assigning duplicate voice tags by detecting potential conflicts and recommending alternative voice tags to the user.

15. A method comprising:
receiving a voice instruction from a user, the voice instruction comprising a command portion and a voice tag portion, wherein the voice tag portion comprises a voice tag corresponding to an item in a library, the voice tag being assigned to the corresponding item by a user when the corresponding item was added to the library;
parsing the voice instruction to identify the command portion and the voice tag portion;
processing the voice tag portion to identify the item in the library corresponding to the voice tag;
accessing the item in the library corresponding to the voice tag; and
processing the command portion to carry out a desired function on the accessed item, in accordance with the voice instruction.

16. The method of claim 15, wherein each voice tag comprises three words or less.

17. The method of claim 15, wherein the items comprise audio, video, text, images, webpages, or presentations.

18. The method of claim 15, wherein the voice instruction further comprises an optional first context portion, an optional keyword portion, an optional second context portion, or an optional delivery portion.

19. The method of claim 15, further comprising receiving a wakeword and a voice command to launch a voice tag retrieval module, before receiving the voice instruction.

20. The method of claim 15, wherein the command portion of the voice instruction comprises a “GET” command or a “SHARE” command.
